(19) United States
(12) Patent Application Publication
(10) Pub. No.: US 2009/0019016 A1
(43) Pub. Date: Jan. 15, 2009

(54) METHOD AND SYSTEM FOR FINDING INFORMATION IN EMAIL UPON OBTAINING SEARCH PERMISSION

(75) Inventors: Sara H. Basson, White Plains, NY (US); Dimitri Kanevsky, Ossining, NY (US); Edward E. Kelley, Wappingers Falls, NY (US); Clifford A. Pickover, Yorktown Heights, NY (US)

Correspondence Address: Cantor Colburn LLP - IBM Endicott, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/774,962

(22) Filed: Jul. 9, 2007

(51) Int. Cl. G06F 17/30

(52) U.S. Cl. 707/4; 707/E17.015

(57) ABSTRACT

Disclosed is a method for finding information contained in email, the method including linking a plurality of email databases with a computing resource operated by a primary user, the plurality of email databases including a primary database operated by the primary user and at least one secondary database operated by at least one secondary user. The method also includes determining criteria to be searched in the email databases, requesting permission from the secondary users to search the secondary databases for the criteria, and obtaining permission from the secondary users to search the secondary databases at the discretion decision of the secondary user. The method further includes employing a universal interface adapter to search the email databases, searching for the criteria in the email databases for which the permission was obtained, finding information including the criteria via the searching, and receiving the information at the primary computing resource.

### BACKGROUND OF THE INVENTION

1. Field of the Invention

The disclosure relates generally to a method and system for finding information in email, and more particularly to a method and system for finding information in email located in a plurality of email databases.

2. Description of Background

Email has become a valuable tool for sending and storing information. It is often very useful to look through old emails for necessary information. Attaching data to an email and sending the email with the data to oneself is a common practice to avoid the hassle of using CDs and USB keys for storing data. Storage of information via email is reliable as long as the email server over which the email is sent allows for archiving of old emails and does not regularly delete email. Such archiving, non-deleting servers include large storage potential, and can offer a valuable data mining resource.

Needed information can be found by searching through the one's own sent and received email. However, this searching cannot reach the valuable email resources of other email users. Thus, there is a need for a reliable and secure service that can compile, search, and retrieve email messages from one's own email as well as the email accounts of others.

### SUMMARY OF THE INVENTION

Disclosed is a method for finding information contained in email, the method including linking a plurality of email databases with a computing resource operated by a primary user, wherein the plurality of email databases includes a primary database that is operated by the primary user and at least one secondary database that is operated by at least one secondary user. The method also includes determining criteria to be searched in the plurality of email databases, requesting permission from the at least one secondary user to search the at least one secondary database for the criteria, and obtaining permission from the at least one secondary user to search the at least one secondary database at a discretionary decision of each of the at least one secondary users. The method further includes employing a universal interface adapter to search the plurality of email databases, searching for the criteria in the plurality of email databases for which the permission was obtained, finding information including the criteria via the searching, and receiving the information at the primary computing resource.

Also disclosed is a system for finding information contained in email, the system including a computing resource configured for operation by a primary user, the computing resource being linked with a plurality of email databases, wherein the plurality of email databases includes a primary database that is operated by the primary user and at least one secondary database that is operated by at least one secondary user. The system, also includes a search engine linked with the computing resource, the search engine being configured to search the plurality of email databases, and a universal interface adapter configured to search the plurality of email databases. The system further includes a security system linked with the search engine and the at least one secondary email database, the security system being configured to allow the at least one secondary user to prevent the search engine from searching the at least one secondary database.

### BRIEF DESCRIPTION OF THE DRAWINGS

The foregoing and other features and advantages of the present invention should be more fully understood from the following detailed description of illustrative embodiments taken in conjuncture with the accompanying Figures in which like elements are numbered alike in the several Figures:

FIG. 1 is a schematic representation of a system for finding information contained in email;

FIG. 2 is a block diagram illustrating a method for finding information contained in email; and

FIG. 3 is a flow chart illustrating an exemplary embodiment of the method for finding information contained in email.

### DETAILED DESCRIPTION OF THE INVENTION

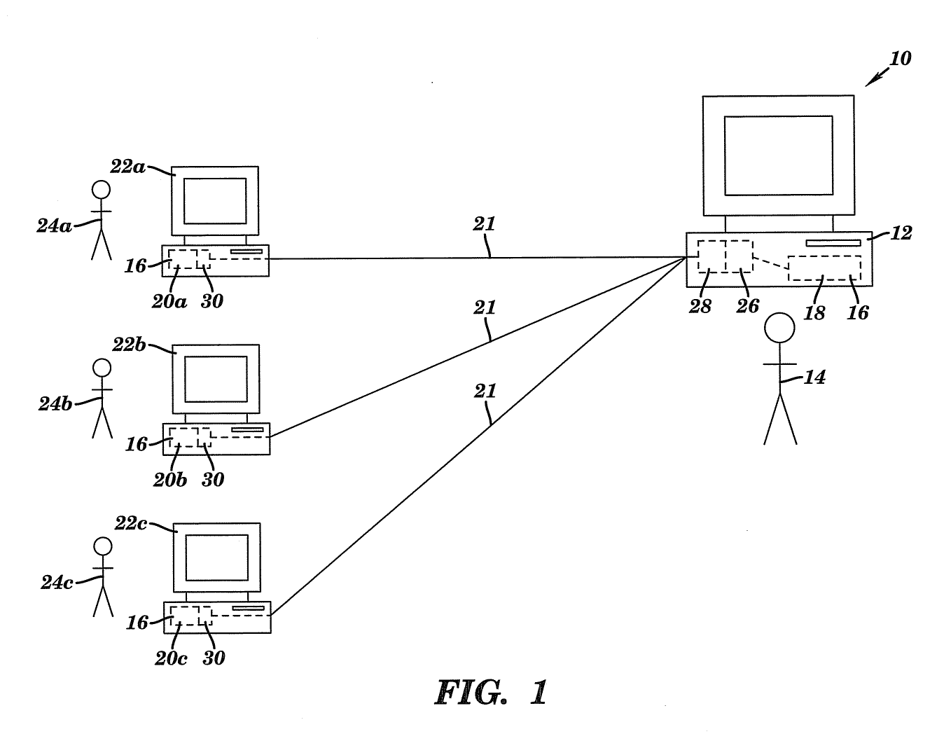

Referring to FIG. 1, a system 10 for finding information contained in email is illustrated. The system 10 includes a computing resource 12 configured for operation by a primary user 14. The computing resource 12 is linked with a plurality of email databases 16, which include a primary database 18 and a plurality of secondary databases. This linking (which is represented in FIG. 1 by linking 21) may be achieved via networking (possibly wireless) of the databases. In the exemplary embodiment of FIG. 1, the plurality of secondary databases is three secondary databases 20a-c, which are associated with three secondary computing resources 22a-c. The primary database 18 is operated by the primary user 14 (i.e. the primary user 14 is the primary account holder of database 18), and the secondary databases 20a-c are operated by secondary users 24a-c (i.e. the secondary users 24a-c are the individual primary account holders of databases 20a-c respectively). It should be appreciated that the plurality of email databases may include the same interfaces or a plurality of different interfaces.

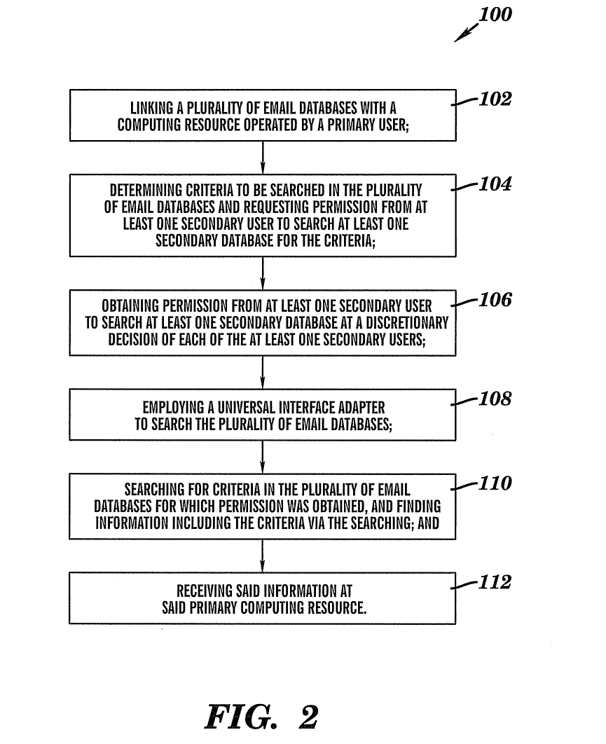

The system 10 also includes a search engine 26 that is linked with the computing resource 12, the primary database 18, and the secondary databases 20a-c. The search engine 26 is configured to search the plurality of email databases 16 (both secondary 20a-c and primary 18). Searching of the possibly different interfaces of the plurality of email databases 16 is achieved via a universal interface adapter 28. The search engine 26 and universal interface adapter 28 will be discussed in greater detail in the description of FIG. 2 below. The system 10 additionally includes a security system 30 that is linked with the search engine and the secondary email databases 20a-c. The security system 30, which also will be discussed in greater detail in the description of FIG. 2 below, is configured to allow the secondary users 24a-c to prevent the search engine 26 from searching the secondary database 20a-c, with prevention being employed at the secondary user's discretion.

Referring now to FIG. 2, a method 100 for finding information contained in email is illustrated. The method 100 includes linking a plurality of email databases 16 with a computing resource 12 operated by a primary user 14, as shown in operational block 102. The method 100 also includes determining criteria to be searched in the plurality of email databases 16, and requesting permission from at least one secondary user 24a-c to search at least one secondary database 20a-c for the criteria, as shown n operational block 104.

Once the primary user 14 determines the criteria to be searched (i.e. keywords, email senders, or subjects), the user 14 enters the criteria into the search engine 26. The search engine 26 then attempts to obtain permission from the secondary users 20a-c to search the secondary databases 20a-c for the criteria. This attempt is filtered through the security system 30 of the individual secondary databases 20a-c. Each secondary user 24a-c can set his or her security system 30 to restrict the manner in which the search engine 26 searches his or her secondary database 20a-c. Searching can be prevented in general, or set to for restriction based on the identity of the primary user 14 or the subject of the criteria. In this manner, the secondary users 24a-c establish a personally comfortable level of searching by the search engine 26 within their respective secondary databases 20a-c. If each of the secondary users 24a-c is comfortable with searching in general, and the criteria of the search and identity of the primary user 14 fall within the set comfort level of the secondary user 24a-c, permission to search is granted by the security system 30. This permission is represented in the method 100 at operational block 106, which illustrates an obtaining of permission from at least one secondary user 24a-c to search at least one secondary database 20a-c at a discretionary decision of each of the at least one secondary users 24a-c.

Once permission is obtained, a universal interface adapter 28 is employed to search the plurality of different interfaces which may be present in the plurality of email databases 16, as is shown in operational block 108. The universal interface adapter 28 is used to efficiently conduct searches throughout the plurality of email databases 16, which could include different interfaces and configurations. In this manner the universal interface adapter 28 obtains necessary information, which will eventually be presented to the primary user 14 in an email interface that he or she is familiar with. The searches discussed with reference to the universal interface adapter 28 are best represented in the method 100 at operational block 110, which illustrates a searching for the criteria in the plurality of email databases for which permission was obtained, and a finding of information including the criteria via the searching.

With the criteria having been searched and found as shown in operational block 110, further security measures may be taken by the security system 30. For example, the security system 30 may be set by each individual secondary user 24a-c such that each individual secondary user 24a-c may view the searched and found information before the it is received by the requesting primary user 14. Necessity for viewing may be set by each individual secondary user 24a-c according to identity of the requesting primary user 14, content of the email included in the found information, sender of the email included in the found information, or date of the email included in the found information. Some email in the secondary databases 20a-c may even be categorized (prior to search) such that it need not be reviewed no matter who is requesting. The secondary users 24a-c may also use the security system 30 to rate email (again prior to search) by the email at a security level, wherein certain levels require review, while others do not. Once found information is viewed, the secondary users 24a-c may allow or deny the information to be received by the primary user 14. It should be appreciated that even allowed information may be censored in part, with such censoring removing information pertaining to email sender, date of email, and/or particular email content.

Once viewed information is allowed by the secondary users 24a-c, it may be received by the requesting primary user 14. This receipt is represented in the method 100 at operational block 112, which illustrates a receiving said information at the primary computing resource 12.

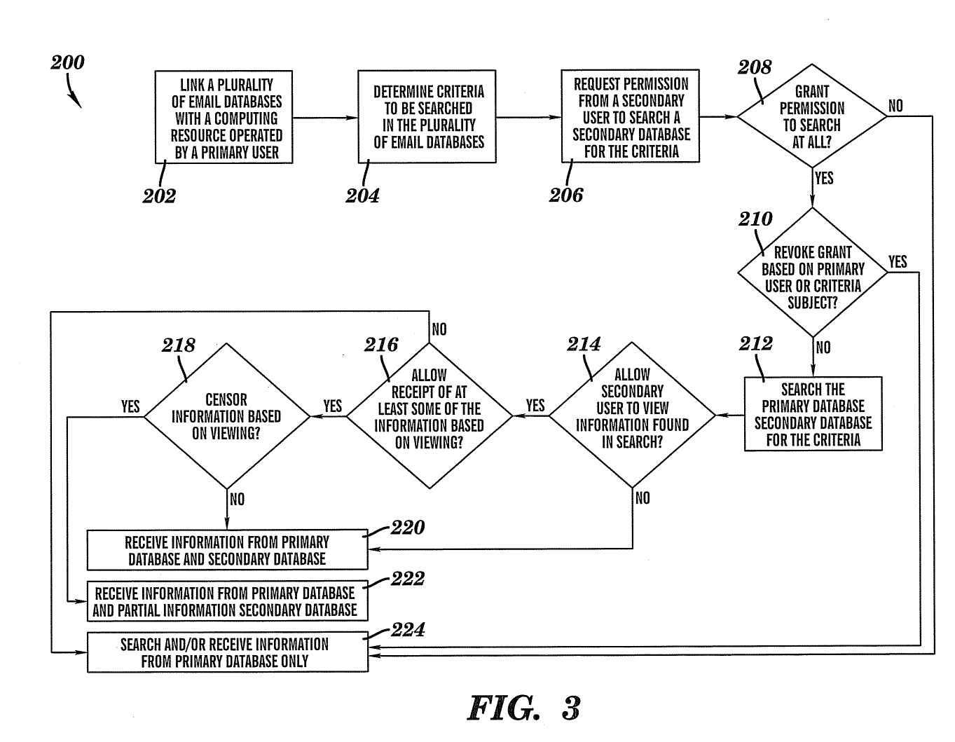

Referring now to FIG. 3, a flow chart 200 illustrating an exemplary embodiment of the method 100 is illustrated. For purposes of clarity, this flow chart 200 illustrates the method 100 as if the only secondary database employed is secondary database 20a (though the method 100 may obviously include many more secondary databases and secondary users). At steps 202-206 of the flow chart 200, the linking, determining, and requesting steps of operational blocks 102 and 104 (see FIG. 2) are shown. At step 208, the requested permission to search at all is either granted or denied. If the user 24a denies permission, via the settings of his or her security system 30, no searching of the secondary database 20a will occur, and a search will occur in the primary database 18 only, as shown at step 224. If permission is granted at step 208, this permission may be revoked at step 210 based on the identity of the primary user 14 and/or the subject matter of the criteria to be searched. If permission is revoked, no searching of the secondary database 20a will occur, and a search will again occur in the primary database 18 only, as shown at step 224. If permission is not revoked however, the search will occur in the primary database 18 and secondary database 20a, as shown at step 212.

Once the search is allowed in the secondary database 20a, the secondary user 24a may be given the option of viewing the information found during the search. Whether or not this viewing takes place depends on how the secondary user 24a has set the security system 30, which is in association with the secondary database 20a. Allowance of this viewing is represented at step 214 of the flow chart 200. If the secondary user 24a has not set the security system 30 to allow a viewing prior to receipt of information by the primary user 14, then the primary user 14 will receive information from the primary database 18 and secondary database 20a, as shown at step 220. However, if the secondary user 24a has set the security system 30 to allow viewing (either of all information or select information based on the settings of the security system 30), a viewing by the user 24a will take place at the secondary computing resource 24a to which the user 24a has access. Upon this viewing, the secondary user 24a will be given the option allowing the primary user 14 to receive at least some of the information being viewed, as is shown at step 216. If the secondary user 24a decides not to allow any of the information to be received, then the primary user 14 will only receive information from the primary database 18, as shown in step 224. If however, the secondary user decides to allow at least some of the information to be received by the primary user 14, the secondary user 24a will then be given the option of censoring this information, as shown at step 218.

At step 218, the secondary user may either choose to allow receipt of all information found in the search, or allow receipt of a partial/censored information found in the search. If the secondary user 24a decides to censor the information, the primary user 14 will receive information from the primary database 18, along with partial/censored information from the secondary database 20a, as shown at step 222. However, if the secondary user 24a chooses not to censor the information, the primary user 14 will receive information from the primary database 18 and secondary database 20a, as shown at step 220.

It should be appreciated that all of the above steps covered in FIGS. 1-3 may be applied to third party databases operated by users to whom the secondary users 24a-c have sent email and third party databases operated by users from whom the secondary users 24a-c have received email. The system 10 may be configured such that these third party databases may receive search requests automatically upon initiation of a search by the primary user 14. The system 10 may also be configured such that completion of a search of the secondary databases 20a-c that has failed to find information that pertains to the search criteria will automatically, or via primary user 14 prompt, generate a search of the third party databases.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or substance to the teachings of the invention without departing from the scope thereof. Therefore, it is important that the invention not be limited to the particular embodiment disclosed as the best mode contemplated for carrying out this invention, but that the invention will include all embodiments falling within the scope of the apportioned claims. Moreover, unless specifically stated any use of the terms first, second, etc. do not denote any order or importance, but rather the terms first, second, etc. are used to distinguish one element from another.

What is claimed is:

1. A method for finding information contained in email, the method comprising:
linking a plurality of email databases with a computing resource operated by a primary user, wherein said plurality of email databases includes a primary database that is operated by said primary user and at least one secondary database that is operated by at least one secondary user;
determining criteria to be searched in said plurality of email databases;
requesting permission from said at least one secondary user to search said at least one secondary database for said criteria;
obtaining permission from said at least one secondary user to search said at least one secondary database at a discretionary decision of each of said at least one secondary users;
employing a universal interface adapter to search said plurality of email databases;
searching for said criteria in said plurality of email databases for which said permission was obtained;
finding information including said criteria via said searching; and
receiving said information at said primary computing resource.

2. The method of claim 1, further including allowing said at least one secondary user to set a security system to enforce restrictions on said searching of said at least one secondary databases.

3. The method of claim 2, wherein said restrictions are based on an identity of said primary user.

4. The method of claim 2, wherein said restrictions are based on a subject of said criteria.

5. The method of claim 1, further including allowing said at least one secondary user to conduct a viewing of said information found in said at least one secondary database during said searching, and offering said at least one secondary user an opportunity to prevent said primary user from receiving said information based on said viewing, wherein said allowing and said offering occurs prior to said receiving of said information at said primary computing resource.

6. The method of claim 5, wherein said allowing and said occurring is restricted to occurring based on at least one of an identity of said primary user, a subject of the criteria, and email content of emails contained in said at least one secondary database.

7. The method of claim 1, further including allowing said at least one secondary user to set said at least one secondary database to censor portions of said information, wherein said setting to censor prevents said receiving of said portions at said primary computing resource.

8. The method of claim 7, wherein said portions are at least one of email sender, date of email, and particular email content.

9. A system for finding information contained in email, the system comprising:
a computing resource configured for operation by a primary user, said computing resource being linked with a plurality of email databases, wherein said plurality of email databases includes a primary database that is operated by said primary user and at least one secondary database that is operated by at least one secondary user;
a search engine linked with said computing resource, said search engine being configured to search said plurality of email databases;
a universal interface adapter configured to search said plurality of email databases; and
a security system linked with said search engine and said at least one secondary email database, said security system being configured to allow said at least one secondary user to prevent said search engine from searching said at least one secondary database

10. The system of claim 12, wherein said security system is configured to allow said at least one secondary user to view information found by said search engine on said at least one secondary database that is operated by said at least one secondary user.

11. The system of claim 13, wherein said security system is configured to allow said at least one secondary user to prevent at least a portion of said information from being received by said primary user at said computing resource.

12. The method of claim 1, wherein said plurality of email databases include a plurality of different interfaces, and said universal interface adapter is configured to search said plurality of different interfaces.

13. The system of claim 9, wherein said plurality of email databases include a plurality of different interfaces, and said universal interface adapter is configured to search said plurality of different interfaces.

14. The method of claim 1, wherein said plurality of email databases includes third party databases operated by users to whom said secondary users have sent email and third party databases operated by users from whom said secondary users have received email.

15. The system of claim 9, wherein said plurality of email databases includes third party databases operated by users to whom said secondary users have sent email and third party databases operated by users from whom said secondary users have received email.
